(19) United States
(12) Patent Application Publication
(10) Pub. No.: US 2016/0195982 A1
(43) Pub. Date: Jul. 7, 2016

(54) DISPLAY DEVICE AND TOUCH SENSOR DEVICE

(71) Applicant: Samsung Display Co., Ltd., Yongin-si (KR)

(72) Inventor: Seong-Keun HA, Asan-si (KR)

(21) Appl. No.: 14/867,767

(22) Filed: Sep. 28, 2015

(30) Foreign Application Priority Data
Jan. 6, 2015 (KR) 10-2015-0001321

(51) Int. Cl. G06F 3/041; G06F 3/042; G06F 3/044

(52) U.S. Cl. CPC G06F 3/0416; G06F 3/044; G06F 3/0421; G06F 3/0412; G06F 2203/04111; G06F 2203/04103

(57) ABSTRACT

A display device includes: a display panel configured to display an image; a first touch panel disposed on the display panel, and including a plurality of driving electrodes extended in a first direction and a plurality of sensing electrodes extended in a second direction; and a second touch panel disposed on the first touch panel, and configured to detect a position region of a touch point, in which the first touch panel applies a touch detection signal only to a driving electrode overlapping the position region of the touch point to detect a position of the touch point.

### CROSS-REFERENCE TO RELATED APPLICATION

This application claims priority to and the benefit of Korean Patent Application No. 10-2015-0001321 filed in the Korean Intellectual Property Office on Jan. 6, 2015, the entire contents of which are incorporated herein by reference.

### BACKGROUND

(a) Field

Embodiments of the present invention relates to a display device and a touch sensor device.

(b) Description of the Related Art

In general, display panels liquid crystal displays (LCDs), organic light emitting diode displays, and the like include a plurality of gate lines and a plurality of data lines connected to a plurality of pixels. The plurality of pixels are formed at crossing points of the gate lines and the data lines. When a gate signal of a gate on voltage is sequentially applied to the plurality of gate lines, a data voltage is applied to the plurality of data lines in response to the gate signal of the gate on voltage, so that image data is written in the plurality of pixels.

A touch sensor device is an input device for recognizing a touch position of a user and inputting a command of the user. The touch sensor device is provided on a front surface of the display panel, and recognizes a position of a touch by a hand or an object, and determines an input signal. A capacitance method, which is one method for implementing a touch sensor, is mainly used.

The capacitance method is a method of detecting a change in capacitance formed between an electrode and a conductive object, such as a finger, that occurs when the device is touched. In the capacitance method, the touch position is detected by sequentially applying a touch detection signal for detecting a touch to a plurality of driving electrodes, and detecting a variance in capacitance of a plurality of sensing electrodes.

Recently, display panels have become very large, and thus the touch sensor device used with the large display panel also needs to be large. When the touch sensor device becomes large, the number of driving electrodes is increased, and a time for applying a touch detection signal to a plurality of driving electrodes is increased. When a time for applying a touch detection signal to a plurality of driving electrodes is increased, a time for detecting a touch position is increased, and performance of the touch sensor device deteriorates.

Further, recently, as one method of more precisely detecting a touch position, a plurality of driving electrodes and a plurality of sensing electrodes are more densely disposed. Even in this case, the number of driving electrodes is increased, and a time for applying a touch detection signal to a plurality of driving electrodes is increased. As a result, performance of the touch sensor device deteriorates.

The above information disclosed in this Background section is only for enhancement of understanding of the background of the invention and therefore it may contain information that does not form the prior art that is already known to a person of ordinary skill in the art.

### SUMMARY

A display device capable of decreasing a time for detecting a touch position, and a touch sensor device, is provided.

Example In one aspect, a display device includes: a display panel configured to display an image; a first touch panel disposed on the display panel, and including a plurality of driving electrodes extended in a first direction and a plurality of sensing electrodes extended in a second direction; and a second touch panel disposed on the first touch panel, and configured to detect a position region of a touch point, in which the first touch panel applies a touch detection signal only to a driving electrode overlapping the position region of the touch point to detect a position of the touch point.

The second touch panel may include: a plurality of light guide plates extended in the first direction; a plurality of light emitting elements positioned at one end of the plurality of light guide plates; and a plurality of light receiving elements positioned at the other end of the plurality of light guide plates, and each of the plurality of light guide plates may overlap at least one of the plurality of driving electrodes, and the position region of the touch point may be a region of a light guide plate in which the touch point is located.

The first touch panel may further include a first touch controller which sequentially applies a first touch detection signal to the plurality of driving electrodes, and receives a first detection signal indicating capacitance of the plurality of sensing electrodes.

The second touch panel may further include a second touch controller which simultaneously applies a second touch detection signal to the plurality of light emitting elements, and receives a second detection signal indicating an intensity of light incident onto the plurality of light receiving elements.

The plurality of light emitting elements may simultaneously emit light according to the second touch detection signal.

The second touch controller may detect the region of the light guide plate having a lower intensity of light than a reference intensity based on the second detection signal, and transmit information on the region of the light guide plate to the first touch controller.

The first touch controller may apply the first touch detection signal only to a driving electrode, which is included in the region of the light guide plate indicated by the information on the region of the light guide plate, to detect a position of the touch point.

The first touch panel may further include an insulating layer interposed between the plurality of driving electrodes and the plurality of sensing electrodes, and capacitance may be formed between the plurality of driving electrodes and the plurality of sensing electrodes.

The plurality of light emitting elements may be any one of an infrared light emitting diode and an infrared lamp.

The plurality of light receiving elements may be any one of an infrared sensing optical diode, a charge-coupled device (CCD), an optical transistor, and an image camera.

The plurality of light guide plates may be formed of a material having a larger refractive index than that of air.

The plurality of light guide plates may be spaced apart from each other by a predetermined distance.

An air layer may exist between the plurality of light guide plates.

A blocking layer for blocking light may be formed between the plurality of light guide plates.

Example In another aspect, touch sensor device includes: a plurality of driving electrodes extended in a first direction; a plurality of sensing electrodes extended in a second direction on the plurality of driving electrodes; a plurality of light guide plates extended in the first direction on the plurality of sensing electrodes; a plurality of light emitting elements positioned at one end of the plurality of light guide plates; and a plurality of light receiving elements positioned at the other end of the plurality of light guide plates; a second touch controller configured to simultaneously apply a second touch detection signal to the plurality of light emitting elements, receive a second detection signal indicating an intensity of light incident onto the plurality of light receiving elements, and detect a region of a light guide plate in which a touch point is located; and a first touch controller configured to sequentially apply a first touch detection signal only to a driving electrode included in the region of the light guide plate among the plurality of driving electrodes, and detect a position of the touch point.

Each of the plurality of light guide plates may overlap at least one of the plurality of driving electrodes.

The second touch controller may detect the region of the light guide plate having a lower intensity of light than a reference intensity based on the second detection signal, and transmit information on the region of the light guide plate to the first touch controller.

The touch sensor device may further include an insulating layer interposed between the plurality of driving electrodes and the plurality of sensing electrodes, in which capacitance may be formed between the plurality of driving electrodes and the plurality of sensing electrodes.

The plurality of light emitting elements may be any one of an infrared light emitting diode and an infrared lamp.

The plurality of light guide plates may be formed of a material having a larger refractive index than that of air.

According to example embodiments example of the present disclosure, it is possible to detect a position of a touch point by applying a sequentially applied touch detection signal only to some of the driving electrodes, thereby decreasing a time for detecting a position of a touch point and improving performance of a touch sensor device.

### BRIEF DESCRIPTION OF THE DRAWINGS

FIG. 1 is a schematic perspective view of a display device according to an example embodiment.

FIG. 2 is a cross-sectional view illustrating a display panel according to an example embodiment.

FIG. 3 is a schematic top plan view of a first touch panel according to an example embodiment.

FIG. 4 is a top plan view illustrating a touch sensor device according to an example embodiment.

FIG. 5 is a schematic top plan view of a second touch panel according to an example embodiment.

FIG. 6 is a top plan view for describing a method of driving the touch sensor device according to an example embodiment.

FIG. 7 is a timing diagram illustrating the method of driving the touch sensor device according to an example embodiment, and an existing method of driving a touch sensor device when only a first touch panel is used.

### DETAILED DESCRIPTION

Hereinafter, example embodiments will be described in detail with reference to the accompanying drawings so that those having ordinary skill in the art may practice the present invention. As those having ordinary skill in the art would realize, the described embodiments may be modified in various different ways, all without departing from the spirit or scope of the present invention.

In addition, in various example embodiments, the same reference numerals are used in respects to the constituent elements having the same constitution and illustrated in the first example embodiment, and in the other example embodiment, only constitution that is different from that of the first example embodiment is illustrated.

In describing the present invention, parts that are not related to the description will be omitted. Like reference numerals generally designate like elements throughout the specification.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element, or intervening elements may also be present. In contrast, when an element is referred to as being “directly on” another element, there are no intervening elements present. Further, when an element is referred to as being “connected to” another element, the element may be “directly coupled” to the other element or “electrically coupled” to the other element through a third element interposed therebetween. In addition, unless explicitly described to the contrary, the word “comprise” and variations such as “comprises” or “comprising”, will be understood to imply the inclusion of stated elements but not the exclusion of any other elements.

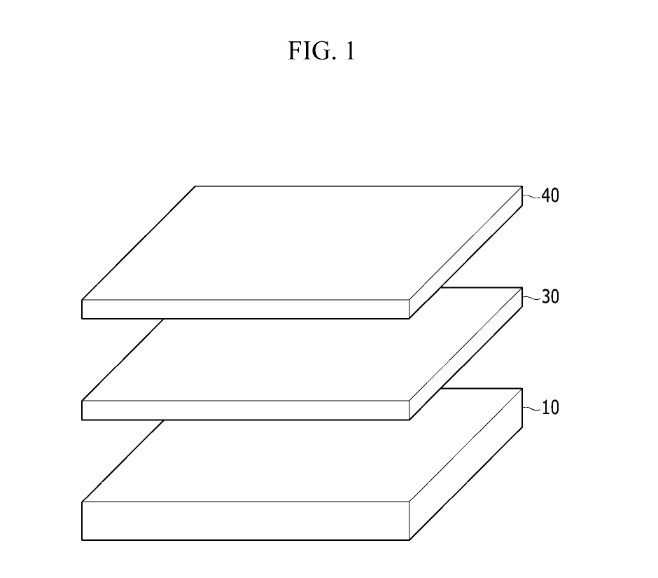

FIG. 1 is a schematic perspective view of a display device according to an example embodiment.

Referring to FIG. 1, a display device includes a display panel 10 for displaying an image, a first touch panel 30 disposed on the display panel 10, and a second touch panel 40 disposed on the first touch panel 30. The first touch panel 30 and the second touch panel 40 form one touch sensor device. An adhesive layer (not illustrated) may be provided between the display panel 10 and the first touch panel 30 to bond the display panel 10 and the first touch panel 30. An adhesive layer (not illustrated) may be provided between the first touch panel 30 and the second touch panel 40 to bond the first touch panel 30 and the second touch panel 40. An optical clear adhesive (OCA) may be used as the adhesive layer.

The display panel 10 includes a plurality of display elements. The plurality of display elements may be an organic light emitting diode (OLED) display, a liquid crystal display (LCD), a field emission display (FED), and a plasma display panel (PDP). That is, the display panel 10 may be a display panel of any one of an OLED, an LCD, an FED, and a plasma display.

The first touch panel 30 may be a capacitive touch panel or a resistive touch panel, and the second touch panel 40 may be an infrared touch panel.

Hereinafter, the present disclosure will describe an example embodiment in which the display panel 10 is a display panel of an LCD, the first touch panel 30 is a capacitive touch panel, and the second touch panel 40 is an infrared touch panel.

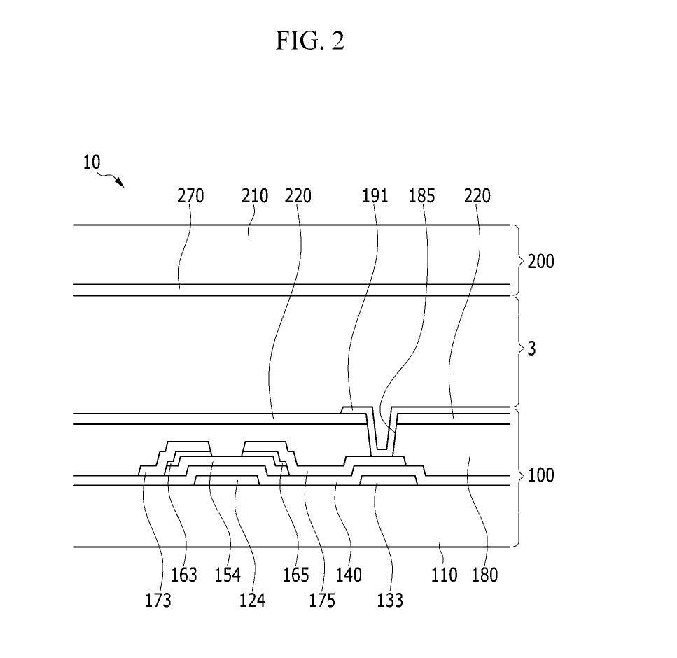

FIG. 2 is a cross-sectional view illustrating the display panel according to an example embodiment.

Referring to FIG. 2, the display panel 10 includes a lower panel 100 and an upper panel 200 which face each other, and a liquid crystal layer 3 interposed between the two display panels 100 and 200.

First, the lower panel 100 will be described.

The lower panel 100 includes gate lines and storage lines on a first substrate 110 formed of transparent glass or plastic. The gate line transmits a gate signal and is mainly extended in a horizontal direction in a plan view (not shown), and includes a gate electrode 124 protruding from the gate line.

The storage line receives a predetermined voltage, and is mostly extended in the horizontal direction. Each storage line includes a storage electrode 133 extended from the storage line.

A gate insulating layer 140 is disposed on the gate electrode 124 and the storage electrode 133. The gate insulating layer 140 may be formed of silicon oxide (SiOx) or silicon nitride (SiNx). The gate insulating layer 140 may have a multilayered structure including at least two insulating layers having different physical properties.

A semiconductor 154 is formed on the gate insulating layer 140. The semiconductor 154 may be formed of hydrogenated amorphous silicon, crystalline silicon, and the like. The semiconductor 154 may include, for example, a semiconductor oxide.

Ohmic contact members 163 and 165, which face each other, are paired up and positioned on the semiconductor 154. The ohmic contact members 163 and 165 may made of a material, such as n+ hydrogenated amorphous silicon doped with an n-type impurity, such as phosphorus, at a high concentration, or may be made of silicide. The ohmic contact members 163 and 165 may be paired up and disposed on the semiconductor 154. When the semiconductor 154 is the semiconductor oxide, the ohmic contact members 163 and 165 may be omitted.

A data line including a source electrode 173 and a drain electrode 175 are disposed on the ohmic contact members 163 and 165 and the gate insulating layer 140.

The data line transmits a data voltage and is mainly extended in a vertical direction in a plan view (not shown) and crosses the gate line.

The drain electrode 175 faces the source electrode 173 based on the gate electrode 124.

One gate electrode 124, one source electrode 173, and one drain electrode 175 form one thin film transistor (TFT) together with the semiconductor 154, and a channel of the thin film transistor is formed in the semiconductor 154 between the source electrode 173 and the drain electrode 175.

The data line and the drain electrode 175 may be made of refractory metal, such as molybdenum, chromium, tantalum, and titanium, or an alloy thereof, and may have a multilayered structure including a refractory metal layer (not illustrated) and a low resistance conductive layer (not illustrated). Examples of the multilayered structure may include a double layer of a chromium or molybdenum (alloy) lower layer and an aluminum (alloy) upper layer, and a triple layer of a molybdenum (alloy) lower layer, an aluminum (alloy) intermediate layer, and a molybdenum (alloy) upper layer. However, the data line 171 and the drain electrode 175 may be made of various metals or conductors.

A passivation layer 180 is formed on the drain electrode 175, the source electrode 173, and the exposed semiconductor 154. The passivation layer 180 may be formed of an inorganic insulating material, such as silicon nitride and silicon oxide, an organic insulating material, or an insulating material having a low dielectric constant which is 4.0 or lower.

An overcoat 220 is disposed on the passivation layer 180. The overcoat 220 may be formed of an inorganic insulating material, and provides a flat surface. The overcoat 220 may be omitted.

The passivation layer 180 and the overcoat 220 includes a contact hole 185 through which the drain electrode 175 is exposed.

A pixel electrode 191 is formed on the overcoat 220. The pixel electrode 191 is formed of a transparent conductive material, for example, ITO and IZO, and is electrically connected with the drain electrode 175 through the contact hole 185.

An alignment layer (not illustrated) may be formed on the pixel electrode 191 and the overcoat 220.

Next, the upper display panel 200 will be described.

The upper panel 200 includes a second substrate 210 and a common electrode 270 disposed on the second substrate 210.

The common electrode 270 has a surface shape, and may be formed on a front surface of the second substrate 210 in a plate shape. The common electrode 270 may be made of a transparent conductive material, such as ITO and IZO. An alignment layer (not illustrated) may be formed under the common electrode 270.

It has been described above that the common electrode 270 is included in the upper panel 200, but the common electrode 270 may be included in the lower panel 100. Further, the structure of the display panel 10 may be variously changed, and the structure of the display panel 10 is not limited in the present disclosure.

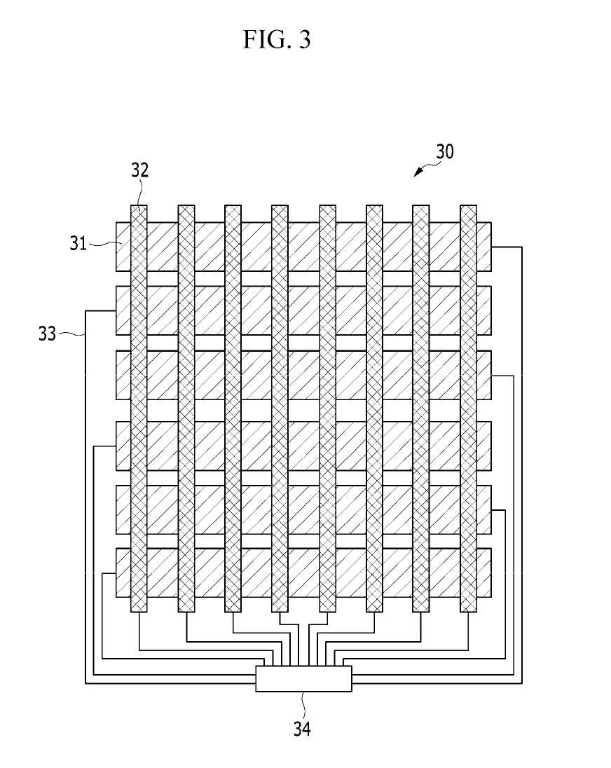

FIG. 3 is a schematic top plan view of a first touch panel according to an example embodiment.

Referring to FIG. 3, the first touch panel 30 includes a plurality of driving electrodes 31 and a plurality of sensing electrodes 32 disposed on the plurality of driving electrodes 31. An insulating layer (not illustrated) is disposed between the plurality of driving electrodes 31 and the plurality of sensing electrodes 32. The plurality of driving electrodes 31 and the plurality of sensing electrodes 32 are connected to a first touch controller 34 through a plurality of first detection wires 33.

The plurality of driving electrodes 31 may be disposed so as to be extended in a first direction (for example, a horizontal direction), and the plurality of sensing electrodes 32 may be disposed so as to be extended in a second direction (for example, a vertical direction) perpendicular to the first direction. The number of driving electrodes 31 and the number of sensing electrodes 32 are not limited. The plurality of driving electrodes 31 and the plurality of sensing electrodes 32 may be formed by a transparent conductive layer, such as an indium tin oxide (ITO). Otherwise, the plurality of driving electrodes 31 and the plurality of sensing electrodes 32 may be formed by a metal mesh. The metal mesh may be fabricated by finely patterning a metal having high conductivity.

The metal mesh may be fabricated by a printing method, an imprinting method, a lithography method, and the like. The printing method is a method of directly forming a transparent electrode (or a wire) on a substrate with a transparent conductive material (or a metal material) by using a gravure or offset method. The imprinting method is a method of forming a transparent electrode (or a wire) by forming a fine pattern on a transparent conductive layer or a metal layer, and then etching the transparent conductive layer (or the metal layer) through the fine pattern. The lithography method is a method of forming a transparent electrode (or a wire) by forming a fine pattern on a substrate through a source, such as light, laser, or electron beam, and etching the transparent conductive layer (or the metal layer) by using the fine pattern.

A plurality of metal patterns forming the metal mesh may be formed of a metal material, such as copper (Cu), aluminum (Al), molybdenum (Mo), and silver (Ag) with a linewidth of 0.1 um to 10 um. The plurality of driving electrodes 31 and the plurality of sensing electrodes 32 formed by the metal mesh have high conductivity and high transparency.

The insulating layer is interposed between the plurality of driving electrodes 31 and the plurality of sensing electrodes 32 to separate the plurality of driving electrodes 31 and the plurality of sensing electrodes 32 from each other. An inorganic insulating material, such as silicon oxide (SiOx) and silicon nitride (SiNx), may be used as the insulating layer. Otherwise, an organic insulating material, such as a cellulose derivative, an olefin-based resin, an acrylic resin, a vinyl chloride-based resin, a styrene-based resin, a polyester-based resin, a polyamide-based resin, a polycarbonate-based resin, a polycycloolefin resin, and an epoxy resin, may be used as the insulating layer.

The plurality of driving electrodes 31 and the plurality of sensing electrodes 32 are separated from each other by the insulating layer, so that capacitance is formed between the plurality of driving electrodes 31 and the plurality of sensing electrodes 32.

The first touch controller 34 sequentially applies a first touch detection signal to the plurality of first detection wires 33 connected to the plurality of driving electrodes 31. The first touch controller 34 also receives a first detection signal indicating capacitance of the plurality of sensing electrodes 32 through the plurality of first detection wires 33 connected to the plurality of sensing electrodes 32. The first touch controller 34 may measure a variance in capacitance of the plurality of sensing electrodes 32 to detect a touch position.

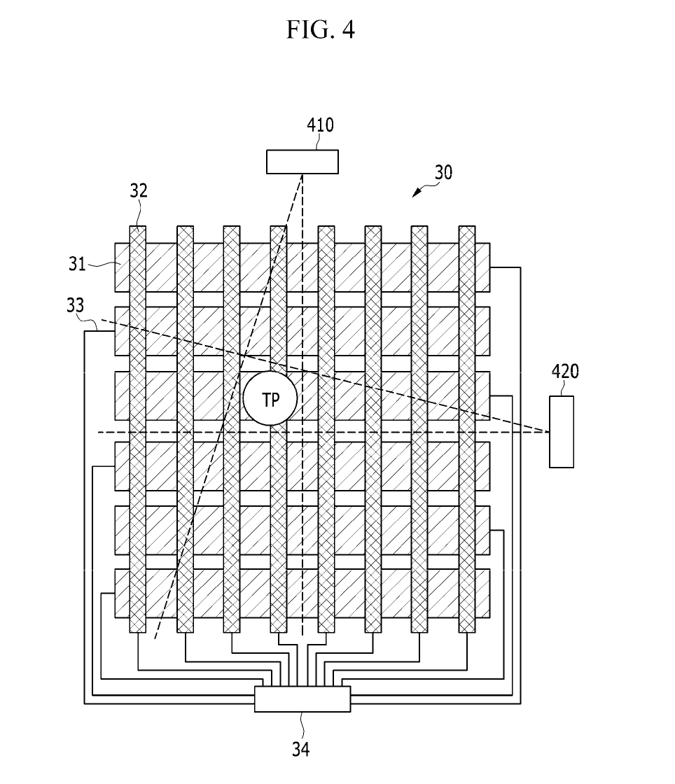

FIG. 4 is a top plan view illustrating a touch sensor device according to the example embodiment.

Referring to FIG. 4, the second touch panel 40 includes at least two infrared sensors 410 and 420 which are capable of recognizing coordinates on a plane. The first infrared sensor 410 is disposed at an upper side or a lower side on the plane of the touch sensor device, and the second infrared sensor 420 is disposed at a left side or a right side on the plane of the touch sensor device. It is possible to detect a rough position of a touch point TP by using the first infrared sensor 410 disposed at the upper side or the lower side on the plane and the second infrared sensor 420 disposed at the left side or the right side on the plane. Because it is enough for the second touch panel 40 to recognize an approximate position of the touch point TP, the second touch panel 40 does not require a large number of infrared sensors for use or a complex algorithm in order to detect an accurate position of the touch point TP. That is, the surface second touch panel 40 of the touch sensor device has a first area, and the approximate position of the touch point TP occurs in a smaller region of that first area, which is the position region of the touch point. The position region of the touch point TP may be identified by touch panel 40.

The approximate position of the touch point TP, i.e., the position region of the touch point TP, measured in the second touch panel 40 may be transmitted to the first touch panel 30, and the first touch panel 30 may sequentially apply the first touch detection signal only to the driving electrodes 31 overlapping a position region of the touch point, received from the first touch panel 30, thereby detecting an accurate, i.e., more specific location of the position of the touch point TP. Using the information received from the second touch panel TP, the first touch panel 30 may identify the touch point TP at a much small and more precise location that the position region of the touch point TP identified by the second touch panel 40.

The second touch panel 40 using the infrared sensor may be provided in various widely-known forms. The kind of second touch panel 40 using the infrared sensor is not limited. Hereinafter, a detailed configuration of the second touch panel 40 as one example embodiment will be described.

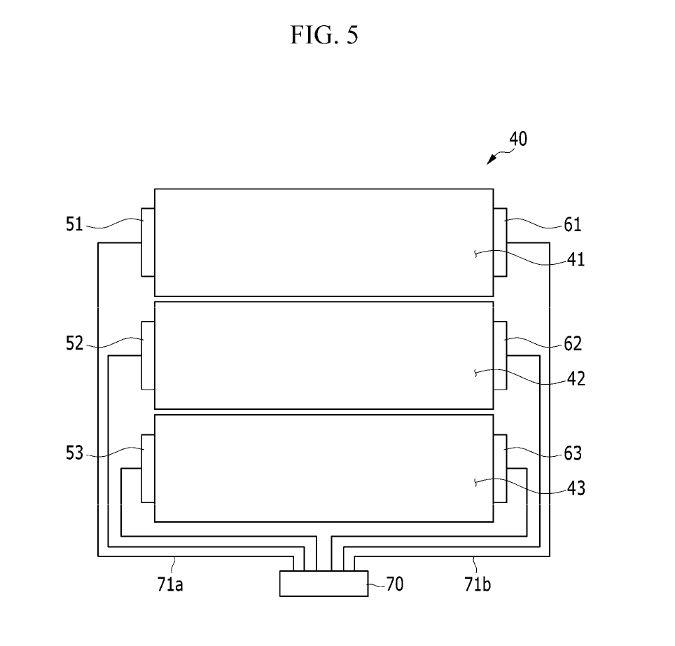

FIG. 5 is a schematic top plan view of the second touch panel according to an example embodiment.

Referring to FIG. 5, the second touch panel 40 includes a plurality of light guide plates 41 to 43, a plurality of light emitting elements 51 to 53 positioned at one end of the plurality of light guide plates 41 to 43, a plurality of light receiving elements 61 to 63 positioned at the other end of the plurality of light guide plates 41 to 43, and a second touch controller 70.

The plurality of light guide plates 41 to 43 is disposed so as to be extended in the first direction (horizontal direction). Each of the plurality of light guide plates 41 to 43 may overlap at least one of the plurality of driving electrodes 31 of the first touch panel 30. The plurality of light guide plates 41 to 43 may be formed of an organic material having a larger refractive index than that of the air. For example, the plurality of light guide plates 41 to 43 may be formed of poly methyl methacrylate (PMMA). Further, the plurality of light guide plates 41 to 43 may be formed of glass having a larger refractive index than that of the air. A thickness of the plurality of light guide plates 41 to 43 may be about 0.5 to 1 mm. The plurality of light guide plates 41 to 43 may be spaced apart from each other by a predetermined distance, and an air layer or a blocking layer for blocking light between the plurality of light guide plates 41 to 43 may be formed between the plurality of light guide plates 41 to 43.

Each of the plurality of light emitting elements 51 to 53 is positioned at one end of each of the plurality of light guide plates 41 to 43. The plurality of light emitting elements 51 to 53 may be an infrared light emitting diode (LED) or an infrared lamp. The plurality of light emitting elements 51 to 53 may emit light of a wavelength having 850 nm to 980 nm. Each of the plurality of light emitting elements 51 to 53 is in contact with one end surface of each of the plurality of light guide plates 41 to 43, so that an air layer does not exist between the plurality of light emitting elements 51 to 53 and the plurality of light guide plates 41 to 43.

The plurality of light receiving elements 61 to 63 may be an infrared sensing optical diode, a charge-coupled device (CCD), an optical transistor, an image camera, and the like. Each of the plurality of light receiving elements 61 to 63 is in contact with the other end surface of each of the plurality of light guide plates 41 to 43, so that an air layer may not exist between the plurality of light receiving elements 61 to 63 and the plurality of light guide plates 41 to 43.

The number of light guide plates 41 to 43, the number of light emitting elements 51 to 53, and the number of light receiving elements 61 to 63 are not limited.

The second touch controller 70 is connected to the plurality of light emitting elements 51 to 53 and the plurality of light receiving elements 61 to 63 through a plurality of second detection wires 71a and 71b. The second touch controller 70 simultaneously applies a second touch detection signal to the plurality of second detection wires 71a connected to the plurality of light emitting elements 51 to 53, and receives a second detection signal indicating an intensity of light incident onto the plurality of light receiving elements 61 to 63 through the plurality of second detection wires 71b connected to the plurality of light receiving elements 61 to 63.

Because the plurality of light guide plates 41 to 43 is formed of a material having a larger refractive index than that of the air, the light emitted from the plurality of light emitting elements 51 to 53 is totally reflected inside the plurality of light guide plates 41 to 43 and incident onto the plurality of light receiving elements 61 to 63. In this case, the intensity of the light incident onto the plurality of light receiving elements 61 to 63 refers to a reference intensity. When an object, such as a finger or a touch pen, is in contact with the light guide plates 41 to 43, the total reflection is broken and the intensity of the light incident onto the plurality of light receiving elements 61 to 63 becomes lower than the reference intensity.

The second touch controller 70 may determine that the touch position is included in a region of the plurality of light guide plates 41 to 43 corresponding to the plurality of light receiving elements 61 to 63 having the lower intensity of light incident than the reference intensity among the plurality of light receiving elements 61 to 63.

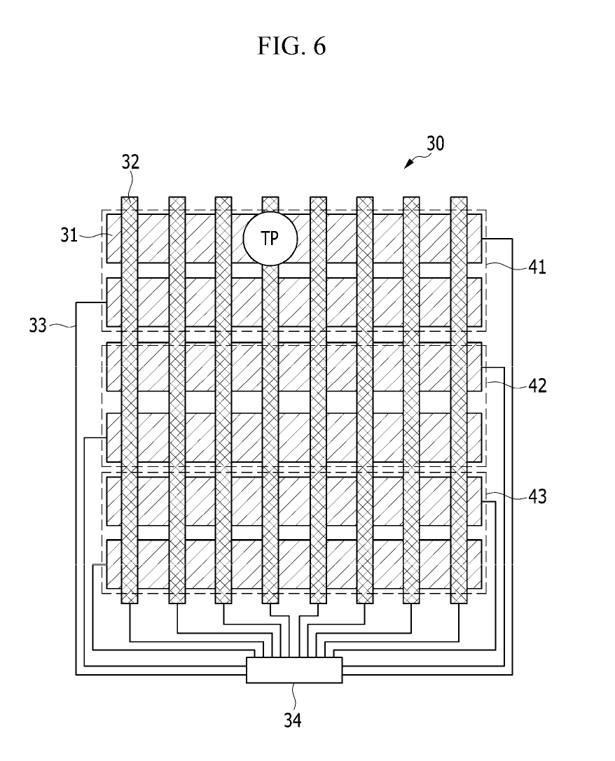

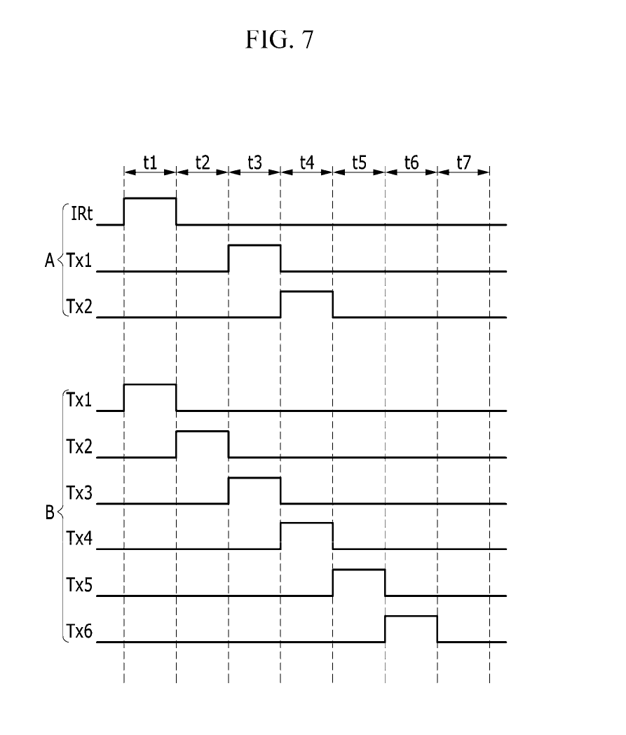

Hereinafter, a method of driving the touch sensor device will be described with reference to FIGS. 6 and 7.

FIG. 6 is a top plan view for describing a method of driving the touch sensor device according to an example embodiment. FIG. 7 is a timing diagram illustrating the method of driving the touch sensor device according to the example embodiment, and a conventional method of driving a touch sensor device when only a first touch panel is used.

Referring to FIGS. 6 and 7, in this example embodiment, among the plurality of light guide plates 41 to 43 exemplified in FIG. 5, the first light guide plate 41 is disposed while overlapping the driving electrodes 31 disposed at the first and second positions from the upper end of the first touch panel 30 exemplified in FIG. 3, the second light guide plate 42 is disposed while overlapping the driving electrodes 31 disposed the third and fourth positions from the upper end of the first touch panel 30, and the third light guide plate 43 is disposed while overlapping the driving electrodes 31 disposed at the fifth and sixth positions from the upper end of the first touch panel 30. In this example, for purposes of description, a touch point TP due to a contact of an object, such as a finger or a touch pen, is present in the firstly disposed driving electrode 31, but the touch point TP may occur in at any position.

First, a process A for detecting a position of the touch point TP by using the first touch panel 30 and the second touch panel 40 will be described.

At a time t1, the second touch controller 70 (FIG. 5) simultaneously applies a second touch detection signal IRt to the plurality of second detection wires 71a connected to the plurality of light emitting elements 51 to 53. The plurality of light emitting elements 51 to 53 simultaneously emit light according to the second touch detection signal IRt. The light is totally reflected in the second light guide plate 42 and the third light guide plate 43 to be incident into the light receiving elements 62 and 63. By contrast, the total reflection of the light is broken at the touch point TP in the first light guide plate 41, and light having a relatively low intensity is incident into the light receiving element 61. The plurality of light receiving elements 61 to 63 transmits a second detection signal, which corresponds to the intensity of incident light to the second touch controller 70.

At a time t2, the second touch controller 70 detects a region of the light guide plate, in which the intensity of light is lower than a reference intensity, based on the second detection signal received from the plurality of light receiving elements 61 to 63. The second touch controller 70 may recognize, based on the second detection signal received from wires 71b, that a position having the lower intensity of light than the reference intensity is the region of the first light guide plate 41, and the touch point TP is located in the region of the first light guide plate 41. The second touch controller 70 transmits information on the region of the first light guide plate 41, at which the touch point TP is located, to the first touch controller 34.

At times t3 and t4, the first touch controller 34 applies first touch detection signals Tx1 and Tx2 only to the driving electrode 31 included in the region of the first light guide plate 41 indicated by the information on the region of the first guide plate 41, and does not apply touch detection signals to the other driving electrodes 31. Here, the firstly and secondly disposed driving electrodes 31 are included in the region of the first light guide plate 41, so that the first touch controller 34 sequentially applies the first touch detection signals Tx1 and Tx2 to the firstly and secondly disposed driving electrodes 31. The first touch controller 34 receives a plurality of first detection signals from the plurality of sensing electrodes 32 in response to the first touch detection signals Tx1 and Tx2.

At a time t5, the first touch controller 34 may detect a position of the touch point TP having a variance in capacitance based on the plurality of first detection signals.

Next, a process B for detecting a position of a touch point TP by using only the first touch panel 30, without using the second touch panel 40, will be described.

At times t1 to t6, the first touch controller 34 sequentially applies first touch detection signals Tx1 to Tx6 from the firstly to sixthly disposed driving electrodes 31. The first touch controller 34 receives a plurality of first detection signals from the plurality of sensing electrodes 32 in response to the first touch detection signals Tx1 to Tx6.

At a time t7, the first touch controller 34 may detect a position of the touch point TP having a variance in capacitance based on the plurality of first detection signals.

As described above, in the case (A) where the first touch panel 30 and the second touch panel 40 are both used according to the present disclosure, a position of a touch point TP is detected by detecting an approximate position region of the touch point TP in the second touch panel 40, and then applying the first touch detection signal only to the driving electrode in the position region detected in the first touch panel 30, thereby rapidly detecting the position of the touch point TP. As exemplified in the case (A) of FIG. 6, the accurate position of the touch point TP may be detected at the time t5. By contrast, in the case (B) where only the first touch panel 30 is used, the first touch detection signal needs to be applied to all of the plurality of driving electrodes 31, so that it takes a relatively long time to detect an accurate position of the touch point TP. As exemplified in the case (B) of FIG. 6, the accurate position of the touch point TP may be detected at the time t7.

Here, for the convenience of the description, only six driving electrodes 31 of the first touch panel 30 are illustrated and described, but more driving electrodes may be actually disposed in the capacitive touch panel, and when an approximate position region of the touch point TP is detected within a relatively short time by using the second touch panel 40 and then the first touch panel 30 is driven only in the corresponding region, it is possible to detect a touch position within a shorter time.

The accompanying drawings and the detailed description of the example embodiments as described above are only as an example, which are used for the purpose of describing the present disclosure but are not used to limit the meanings or the scope of the present invention. Therefore, the person skilled in the art would understand that various modifications and other example embodiments are feasible.

### DESCRIPTION OF SYMBOLS

10: Display panel
30: First touch panel
40: Second touch panel

What is claimed is:

1. A display device, comprising:
a display panel configured to display an image;
a first touch panel disposed on the display panel, and including a plurality of driving electrodes extended in a first direction and a plurality of sensing electrodes extended in a second direction; and
a second touch panel disposed on the first touch panel, and configured to detect a position region of a touch point,
wherein the first touch panel applies a touch detection signal only to a driving electrode overlapping the position region of the touch point to detect a position of the touch point.

2. The display device of claim 1, wherein:
the second touch panel includes:
a plurality of light guide plates extended in the first direction;
a plurality of light emitting elements disposed at one end of the plurality of light guide plates; and
a plurality of light receiving elements positioned at the other end of the plurality of light guide plates, and
each of the plurality of light guide plates overlaps at least one of the plurality of driving electrodes, and the position region of the touch point is a region of a light guide plate in which the touch point is located.

3. The display device of claim 2, wherein:
the first touch panel further includes a first touch controller which sequentially applies a first touch detection signal to the plurality of driving electrodes, and receives a first detection signal indicating capacitance of the plurality of sensing electrodes.

4. The display device of claim 3, wherein:
the second touch panel further includes a second touch controller which simultaneously applies a second touch detection signal to the plurality of light emitting elements, and receives a second detection signal indicating an intensity of light incident onto the plurality of light receiving elements.

5. The display device of claim 4, wherein:
the plurality of light emitting elements simultaneously emits light according to the second touch detection signal.

6. The display device of claim 4, wherein:
the second touch controller detects the region of the light guide plate having a lower intensity of light than a reference intensity based on the second detection signal, and transmits information on the region of the light guide plate to the first touch controller.

7. The display device of claim 6, wherein:
the first touch controller applies the first touch detection signal only to a driving electrode, which is included in the region of the light guide plate indicated by the information on the region of the light guide plate, to detect a position of the touch point.

8. The display device of claim 2, wherein:
the first touch panel further includes an insulating layer interposed between the plurality of driving electrodes and the plurality of sensing electrodes, and capacitance is formed between the plurality of driving electrodes and the plurality of sensing electrodes.

9. The display device of claim 2, wherein:
the plurality of light emitting elements is any one of an infrared light emitting diode and an infrared lamp.

10. The display device of claim 9, wherein:
the plurality of light receiving elements is any one of an infrared sensing optical diode, a charge-coupled device (CCD), an optical transistor, and an image camera.

11. The display device of claim 10, wherein:
the plurality of light guide plates is formed of a material having a larger refractive index than that of air.

12. The display device of claim 11, wherein:
the plurality of light guide plates is spaced apart from each other by a predetermined distance.

13. The display device of claim 12, wherein:
an air layer exists between the plurality of light guide plates.

14. The display device of claim 13, wherein:
a blocking layer for blocking light is formed between the plurality of light guide plates.

15. A touch sensor device, comprising:
a plurality of driving electrodes extended in a first direction;
a plurality of sensing electrodes extended in a second direction on the plurality of driving electrodes;
a plurality of light guide plates disposed in the first direction on the plurality of sensing electrodes;
a plurality of light emitting elements positioned at one end of the plurality of light guide plates; and
a plurality of light receiving elements positioned at the other end of the plurality of light guide plates;
a second touch controller configured to simultaneously apply a second touch detection signal to the plurality of light emitting elements, receive a second detection signal indicating an intensity of light incident onto the plurality of light receiving elements, and detect a region of a light guide plate in which a touch point is located; and
a first touch controller configured to sequentially apply a first touch detection signal only to a driving electrode included in the region of the light guide plate among the plurality of driving electrodes, and detect a position of the touch point.

16. The touch sensor device of claim 15, wherein:
each of the plurality of light guide plates overlaps at least one of the plurality of driving electrodes.

17. The touch sensor device of claim 15, wherein:
the second touch controller detects the region of the light guide plate having a lower intensity of light than a reference intensity based on the second detection signal, and transmits information on the region of the light guide plate to the first touch controller.

18. The touch sensor device of claim 15, further comprising:
an insulating layer interposed between the plurality of driving electrodes and the plurality of sensing electrodes,
wherein capacitance is formed between the plurality of driving electrodes and the plurality of sensing electrodes.

19. The touch sensor device of claim 15, wherein:
the plurality of light emitting elements is any one of an infrared light emitting diode and an infrared lamp.

20. The touch sensor device of claim 15, wherein:
the plurality of light guide plates is formed of a material having a larger refractive index than that of air.
